(19) United States
(12) Patent Application Publication
(10) Pub. No.: US 2010/0212017 A1
(43) Pub. Date: Aug. 19, 2010

(54) SYSTEM AND METHOD FOR EFFICIENT TRUST PRESERVATION IN DATA STORES

(75) Inventors: Tiancheng Li, West Lafayette, IN (US); Xiaonan Ma, Sunnyvale, CA (US)

Correspondence Address: Kenneth L. Sherman, Esq.;c/o MYERS ANDRAS SHERMAN LLP, 19900 MacArthur Blvd., Suite 1150, Irvine, CA, 92612, US

(73) Assignee: International Business Machines Corporation, Armonk, NY (US)

(21) Appl. No.: 12/388,422

(22) Filed: Feb. 18, 2009

(51) Int. Cl. G06F 21/00

(52) U.S. Cl. 726/26

(57) ABSTRACT

The invention provides a method and system for preserving trustworthiness of data, the method includes storing data on an untrusted system, and committing the data to a trusted computing base (TCB). The committing includes upon an end of a predetermined time interval, transmitting a constant size authentication data from the untrusted system to the TCB, and the TCB preserving trustworthiness of the authentication data based on performing a single hash operation of a first root and a second root of a general hash tree representing authenticated data.

### BACKGROUND OF THE INVENTION

1. Field of the Invention

The present invention relates generally to data authentication, and in particular, to storing data on an untrusted machine and preserving the trustworthiness efficiently by minimizing the resource usage on a trusted computing base.

2. Background Information

Today's information is increasingly stored electronically. While digital data records are easy to store and convenient to retrieve, they are also relatively easy to be tampered with without being detected. Given the amount of critical information stored in digital form, the importance of ensuring that such information is trustworthy and credible can never be overestimated. One area where being able to preserve and verify the trustworthiness is of particular importance is regulatory compliance. As the number and scope of recordkeeping regulations such as SEC rule 17-4a and HIPAA (Health Insurance Portability and Accountability Act) grow, today's businesses are facing a higher degree of regulation and accountability than ever. Failure to comply with such regulations could result in hefty fines and jail sentences.

Vendors have provided a number of WORM (Write-Once Read-Many) solutions to help manage data. Earlier versions rely on physical WORM media, such as CD-R and optical-magnetic technology. Due to performance and cost considerations, they have been replaced by recent WORM offerings which use standard rewritable hard drives but enforce the WORM properties through software. However, the protection offered by these systems is often limited, especially in the regulatory compliance environment where chances for insider attacks are quite high. Previous high-profile industry scandals have shown that the ones who are motivated to tamper with existing data are often high level executives trying to erase evidence or cover up their wrongdoings. Not only do they have physical and administrative access to the data systems, the high stakes involved provide incentives for launching sophisticated and resourceful attacks.

Existing solutions are not secure because: (1) software protection is based on the assumption that the adversary can not break into the system, and securing a large/complicated software system is difficult; (2) having physical access means that the attacker may access the storage device directly, bypassing all the protection mechanisms; (3) data migration, which is needed in cases such as upgrading to new systems or disaster recovery, may create windows of vulnerability; (4) solutions based on CAS (Content Addressed Storage) technology are simply pushing the problem to a higher level since the CAS are often managed by untrusted systems; (5) existing solutions focus on protecting reference data, but not metadata structures, and (6) even if the systems are secure, they do not provide a means for an auditor to verify the correctness of data, therefore unless the auditor has direct access to the data system, which is often not the case, the result produced by a query could be altered before it reaches the requester.

Preserving the trustworthiness of fixed-content data records is typically straight-forward. One simple approach is to compute a secure one-way hash of the content and attributes of the data record, and have the trusted computing base (TCB) sign it using its private key, for example, Sign(H(data), H(metadata), timestamp). Such a signature can then be used later to verify the integrity of the data record and its creation time. For regulatory compliance, the metadata typically includes some retention attributes that specifies when the object will expire so the signature can be used to verify whether the object is deleted legitimately. If we want to minimize the information that needs to be maintained after an object is removed, the signature can be slightly modified to be: Sign(H(data), H(metadata—retention attr), retention attr, timestamp). Better efficiency can be achieved by grouping hashes of newly created data records together and have the TCB generate one signature for the whole batch.

However, given the huge amount of data in today's information systems, data are typically accessed through some form of metadata structure such as directories and search indexes. Unlike fixed-content data objects, these meta-data structures need to be updated frequently as data objects are inserted or removed. This introduces additional vulnerability since now instead of tampering with the data directly, an adversary could also tamper with the metadata structure to hide information or point the auditor in the wrong direction. Recent research works have proposed efficient append-only metadata structures that are suitable to be stored on WORM storage. However, the dynamic nature of metadata structures makes it much more challenging to preserve their trustworthiness efficiently. Simply computing a one-way hash for the whole metadata structure would be prohibitively expensive as each update has to be verified by the TCB (unlike with fixed-content objects, the TCB cannot blindly sign or store a new hash for a dynamic metadata structure without verifying the legitimacy of the update).

A simple example of an append-only data structure is an audit log which is organized based on file IDs (or file names). The whole log can be divided into many append-only segments, one for each file. A common type of query for audit logs in regulatory compliance environments is to retrieve all the log entries corresponding to a specified file. To meet the integrity to completeness requirements in such a query, we need to be able to prove the number of log entries contained is correct and up-to-date, and the integrity of each log entry.

Using an append-only data structure such as the ones mentioned above, we can break down a metadata structure into many small pieces (called pages), each being append-only. While this allows the TCB to more efficiently verify whether an update on an individual piece is valid by checking whether the update overwrites any existing data in the page by maintaining a separate hash for each unit, this approach is not storage-efficient for the TCB.

Given the size of today's data set, the number of hashes required by such metadata structures would far exceed the capacity of the secure storage inside the TCB and therefore would have to be stored on the main system which is untrusted. The TCB could encrypt or sign these hashes to prevent them from being tampered with. During each update, the TCB would be presented with the current content of the page, the current signature and the update. The TCB would then verify that the content matches the signature and the update, and would then verify that the update is legitimate. However, this does not prevent an adversary from launching a “replay” attack by submitting an earlier version of the page content/signature with an update, effectively hiding existing data. Therefore, although the TCB does not have room to store individual state information for each page, it has to somehow “remember” the current version of each page.

A conventional approach to authenticate a large dynamic data structure is to use a Merkle hash tree. The Merkle hash tree is a binary tree, where each leaf of the tree contains the hash of a data value, and each internal node of the tree contains the hash of its two children. The verification of data values is based on the fact that the root of the Merkle hash tree is authenticated either through a trusted party or a digital signature. To verify the authenticity of a data value, the prover has to send the verifier the data value itself together with values stored in the siblings of nodes on the path from the data value to the root of the Merkle tree. The verifier can iteratively compute the hash values of nodes on the path from the data value to the root. The verifier can then check if the computer root value matches the authenticated root value. The security of the Merkle tree is based on the collision resistance of the hash function; an adversary who can successfully authenticate a bogus data value must have a hash collision in at least one node on the path from the data value to the root. Using a Merkle tree, the TCB only needs to maintain the root of the tree in its secure memory. The price for solving the storage problem, however, is higher computation and communication overhead for the TCB. Now for each page update, the amount of computation and the size of the verification object (VO) is now log(N), where N is the total number of pages. In a large archive system with high object ingestion rate and where each object insertion could trigger a number of metadata updates (e.g., full-text indexes), the TCB could easily be overwhelmed.

### SUMMARY OF THE INVENTION

The invention provides a method and system for preserving trustworthiness of data, the method includes storing data on an untrusted system, and committing the data to a trusted computing base (TCB). The committing includes upon an end of a predetermined time interval, transmitting a constant size authentication data from the untrusted system to the TCB, and the TCB preserving trustworthiness of the authentication data based on performing a single hash operation of a first root and a second root of a general hash tree representing authenticated data.

Another embodiment involves a system for preserving trustworthiness of data. The system comprising: at least one untrusted module configured to store data, and a trusted computing base (TCB) module coupled to the untrusted module. The TCB configured to authenticate the data, wherein upon an end of a predetermined time interval, the untrusted module transmits a constant size authentication data to the TCB for commitment, and the TCB preserves trustworthiness of the authentication data based on performing a single hash operation of a first root and a second root of a general hash tree representing authenticated data.

Yet another embodiment involves a computer program product for preserving trustworthiness of data that causes a computer to store data on an untrusted system, and commit the data to a trusted computing base (TCB). The commit further causes the computer to: upon an end of a predetermined time interval, transmit constant size authentication data from the untrusted system to the TCB, and the TCB preserves trustworthiness of the authentication data based on performing a single hash operation of a first root and a second root of a general hash tree representing authenticated data.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 illustrates a trusted system according to one embodiment of the invention;

FIG. 2 illustrates a distributed trusted system according to an embodiment of the invention;

FIG. 3 illustrates a general tree structure for representing authenticated data according to an embodiment of the invention; and

FIG. 4 illustrates a block diagram of a process for authenticating data according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments for preserving trustworthiness of data while reducing the computations required by a trusted computing base, as well as operation and/or component parts thereof. While the following description will be described in terms of authentication of data and devices for clarity and to place the invention in context, it should be kept in mind that the teachings herein may have broad application to all types of systems, devices and applications.

The invention provides a method and system for preserving trustworthiness of data, the method includes storing data on an untrusted system, and committing the data to a trusted computing base (TCB). The committing includes, upon an end of a predetermined time interval, transmitting a constant size authentication data from the untrusted system to the TCB, and the TCB preserving trustworthiness of the authentication data based on performing a single hash operation of a first root and a second root of a general hash tree representing authenticated data.

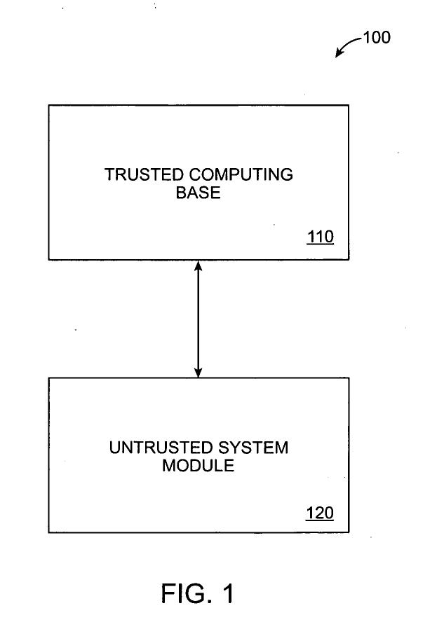

FIG. 1 illustrates a system 100 including a separate Trusted Computing Base (TCB) 110 and an untrusted system module 120. System 100 reduces the storage, computation and communication overhead on the TCB 110 as O(1) (having a single operation overhead). Assuming that there are m updates to N unique metadata pages in a batch (multiple updates to the same page within a batch can be combined as one), where a straight-forward Merkle tree approach incurs computation and communication overhead of O(mlog N) on the TCB 110.

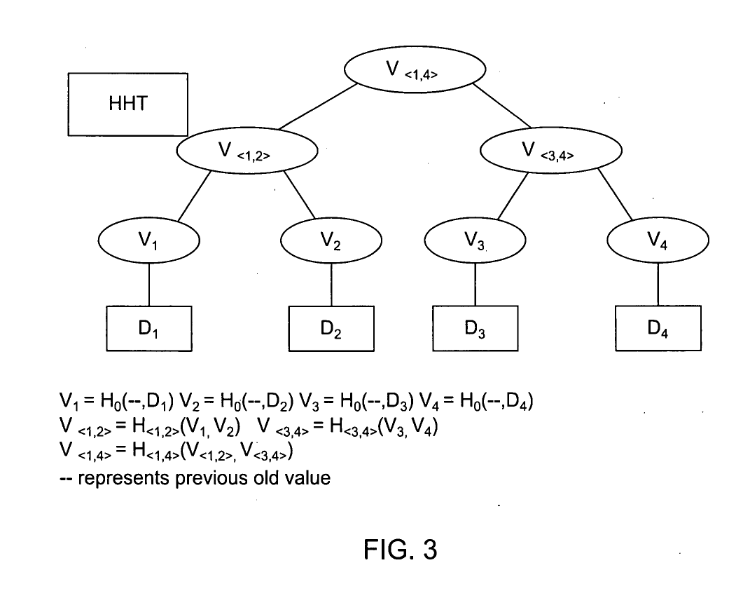

In one embodiment, a general hash tree (GHT) is used as an authenticated data structure (shown in FIG. 3) on TCB 110. The total number of pages in the metadata structure is represented as N (in FIG. 3, N=4) and the metadata pages are represented as P₁, P₂, . . . , P_{N}. TCB 110 builds a general hash tree (GHT) where the i-th leaf stores information relating to the i-th metadata page (i=1, 2, . . . , N). The height of the general hash tree is denoted as ht=log N. Each internal node of the GHT is computed as the hash of its two children nodes. However, unlike a Merkle tree where the same hash function is used throughout the tree, different hash functions are applied at different internal nodes in the GHT according to one embodiment. The value of an internal node is represented as Vᵢ_{₁}ᵢ_{₂} and the hash function for computing Vᵢ_{₁}ᵢ_{₂} is represented as Hᵢ. In other words, Vᵢ_{₁}ᵢ_{₂} is computed as Vᵢ_{₁}ᵢ_{₂}=Hᵢ(Vⱼ_{₁}ⱼ_{₂}, Vₖ_{₁}ₖ_{₂}) where Vⱼ_{₁}ⱼ_{₂} and Vₖ_{₁}ₖ_{₂} are the two children nodes of Vᵢ_{₁}ᵢ_{₂}.

In one embodiment, the hash functions used for computing the internal nodes belong to a homomorphic hashing family {H} that satisfies the following homomorphic property: Hⱼ(Hᵢ(x₀,y₀), Hᵢ(x₁,y₁))=Hᵢ(Hⱼ(x₀,x₁), Hⱼ(y₀,y₁)) for any Hᵢ, Hⱼε H. In one embodiment, we define H₁(x,y)=fl₁(x)fr₁(y), where f_{y}(x)=x^{y} mod n, a homomorphic hash function based on the Rivest-Shamir algorithm (RSA) assumption where n is the RSA modulus. It is straight-forward to prove that such a hashing family satisfies the above homomorphic property.

Next it is shown how the parameters {lᵢ, rᵢ} used in a particular hash function Hᵢ are generated. In one embodiment a tag value and an exponent value are defined for each node in the GHT. The tag value of the i-th leaf is defined to be e₁ (i=1, 2, . . . , N), where e₁ belongs to a set of distinct prime numbers {e₁, e₂, . . . , e_{N}}. The tag value of an internal node is defined as the product of the tag values of its two children. Finally, the exponent value of a node is defined as the tag value of its sibling.

In the example illustrated in FIG. 3, the tag values of V₁ and V₂ are e₁ and e₂ respectively, and the tag value for V₁₂ is e₁e₂. The exponent values of V₁ and V₂ are e₂ and e₁ respectively, and the exponent value of V₁₂ is e₃e₄. Next, l₁ is defined as the exponent value of Vᵢ_{₁}ᵢ_{₂}'s left child and rᵢ as the exponent of Vᵢ_{₁}ᵢ_{₂}'s right child. The way the exponent values are generated has the following property. In one embodiment, the exponents of the siblings of nodes on the path from the leaf V₁ to the root are defined as E₁, E₂, . . . , Eₕₜ, respectively. In one embodiment, the greatest common denominator (gcd) gcd (E₁, E₂, . . . , Eₕₜ)=eᵢ.

Finally, we determine the values stored at the leaves of the general hash tree. The time is divided into time intervals. The untrusted system module 120 communicates with the TCB 110 at the end of each interval. Let n(i) denote the number of data blocks relating to the i-th metadata page up to the end of an interval and that data entries are Dᵢ₁, Dᵢ₂, . . . , Dᵢₙ₍ᵢ₎. The value stored at the i-th leaf is Vᵢ, which is computed as Vᵢ=H₀(H₀( . . . H₀(H₀(h(Dᵢ₁), h(Dᵢ₂)), h(Dᵢ₃)) . . . ), h(Dᵢₙ₍₁₎)), where H₀(x,y)=xy^{e0} mod n and e₀ is a distinct prime number from {e₁, e₂, . . . , e_{N}}. Therefore, that H₀ ε H.

In one embodiment, the untrusted system module 120 needs to submit only a constant size of authentication data to the TCB 110 at the end of each interval. In one embodiment, two leaves of the general hash tree are defined as V₁ and V₂ with their parent being V₁₂=H₁(V₁,V₂). For two new data d₁ and d₂ and the new parent of the two leaves is computed. We denote v₁=h(d₁) and v₂=h(d₂). The new parent is computed as:

$${H}_{1} ( {H}_{0} ( {V}_{1} , {v}_{1} ) , {H}_{0} ( {V}_{2} , {v}_{2} ) ) = {H}_{0} ( {H}_{1} ( {V}_{1} , {V}_{2} ) , {H}_{1} ( {v}_{1} , {v}_{2} ) ) \\ = {H}_{0} ( {V}_{12} , {v}_{12} )$$

where v₁₂=H₁(v₁,v₂).

The root of the GHT is iteratively computed in this manner and the new root of the GHT is computed as Rₜ₊₁=H₀(Rₜ,rₜ) where Rₜ₊₁ is the root of the GHT and the end of the interval t+1, Rₜ is the root of the GHT at the end of interval t, and rₜ is the root of the general hash tree where the leaves are the new data (i.e., v₁, v₂, . . . ).

In other words, the new root Rₜ₊₁ is computed based on the old root Rₜ and the root rₜ of a new GHT, where the leaves are the hashes of the new log entries. In one embodiment, the work of computing rₜ is handled by the untrusted system module 120. At the end of each interval, the untrusted system module 120 computes rₜ and transmits to the TCB 110. The TCB 110 can then compute the new root through one single hash operation; the new root is computed as Rₜ₊₁=H₀(Rₜ, rₜ). The TCB 110 then removes the old root Rₜ and stores the new root Rₜ₊₁.

The construction of the verification object (VO) is similar to that in the Merkle tree. To prove the authenticity of the data relating to the i-th metadata page, the untrusted system module 120 returns the siblings of all nodes on the path from Vᵢ to the root, together with the data relating to the i-th metadata page.

To verify the authenticity of the data relating to the i-th metadata page, a verifier in the untrusted system module 120 can reconstruct the general hash tree and compute the root of the general hash tree. The verifier can then obtain the value of the root obtained from the TCB 110 and compare it with the computed root value. The verifier accepts if and only if these two values match.

Table I below shows the complexity of one embodiment (in the “our app.” row) compared with that of the Merkle tree based approach (in the “MT app.” row), assuming that updates can be batched and the number of updates in a batch is m, the total number of pages in the data structure is N. The verification time and VO size refer to the computation and communication overhead for verifying the correctness of a single page.

TABLE I

| | Storage | Comm. | Comp. | Comm. | Comp. |
|---|---|---|---|---|---|
| | (TCB) | (MS, TCB) | (TCB) | (MS, Verifier) | (Verifier) |
| MT | O(1) | O(m · log N) | O(m · log N) | O(log N) | O(log N) |
| App. | | | | | |
| Our | O(1) | O(1) | O(1) | O(log N) | O(log N) |
| App. | | | | | |

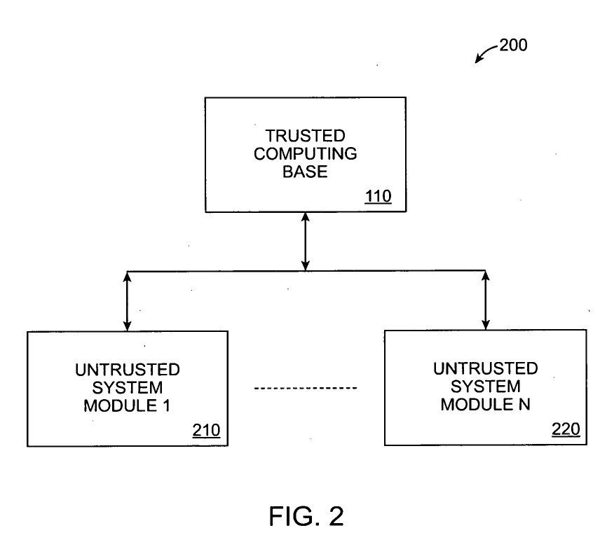

FIG. 2 illustrates a distributed system 200 according to one embodiment. In one embodiment, the system 200 is a distributed network, including a plurality of untrusted system modules 1 210 to N 220, and a TCB 110 that authenticates data on all untrusted system modules in system 200.

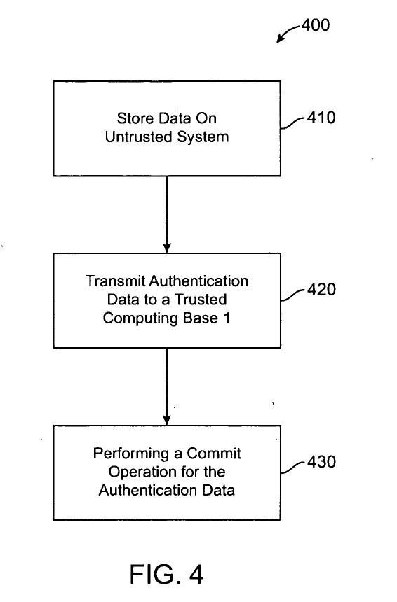

FIG. 4 illustrates a block diagram of an authentication process 400. Process 400 begins with block 410 where data is first stored on an untrusted system module, such as system module 120. Next, in block 420 authentication data is transmitted to a TCB, such as TCB 110. In block 430, a commit operation (as described above) is performed for the authentication data between an untrusted system module and a TCB, such as TCB 110. Therefore data and metadata are stored and the trustworthiness is preserved efficiently by minimizing the resource usage on the TCB. In this embodiment, most of the computations are handled by the untrusted system module.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device.

The medium can be electronic, magnetic, optical, or a semiconductor system (or apparatus or device). Examples of a computer-readable medium include, but are not limited to, a semiconductor or solid state memory, magnetic tape, a removable computer diskette, a RAM, a read-only memory (ROM), a rigid magnetic disk, an optical disk, etc. Current examples of optical disks include compact disk-read only memory (CD-ROM), compact disk-read/write (CD-R/W) and DVD.

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other modifications may occur to those ordinarily skilled in the art.

What is claimed is:

1. A method for preserving trustworthiness of data, the method comprising:
storing data on an untrusted system; and
committing the data to a trusted computing base (TCB), wherein said committing comprises:
upon an end of a predetermined time interval, transmitting a constant size authentication data from the untrusted system to the TCB; and
the TCB preserving trustworthiness of the authentication data based on performing a single hash operation of a first root and a second root of a general hash tree representing authenticated data.

2. The method of claim 1, wherein the committing comprises computing a third root of the general hash tree based on the hash of the first root and the second root.

3. The method of claim 1, wherein the committing further comprises generating the third root and comparing the third root with a computed root value.

4. The method of claim 3, wherein the hash tree including a plurality of leaves each storing information relating to a corresponding metadata page.

5. The method of claim 3, wherein each internal node of the tree is computed as a hash of its children nodes.

6. The method of claim 5, wherein different hash functions are applied at different internal nodes.

7. The method of claim 6, wherein the different hash functions belong to a homomorphic hashing family.

8. The method of claim 5, further comprising:
computing a tag value and an exponent value for each internal node.

9. The method of claim 8, wherein the tag value is a product of tag values of the tag's two children, and the exponent value is the tag value of the node's sibling.

10. A system for preserving trustworthiness of data, comprising:
at least one untrusted module configured to store data; and
a trusted computing base (TCB) module coupled to the untrusted module, the TCB configured to authenticate the data,
wherein upon an end of a predetermined time interval, the untrusted module transmits a constant size authentication data to the TCB for commitment, and the TCB preserves trustworthiness of the authentication data based on performing a single hash operation of a first root and a second root of a general hash tree representing authenticated data.

11. The system of claim 10, wherein the TCB preserves trustworthiness by further computing a third root of the general hash tree based on the hash of the first root and the second root.

12. The system of claim 11, wherein each internal node of the tree is computed as a hash of its children nodes.

13. The system of claim 12, wherein different hash functions are applied at different internal nodes.

14. The system of claim 13, wherein the different hash functions belong to a homomorphic hashing family.

15. The system of claim 10, further comprising:
a distributed network including a plurality of untrusted module sub-systems, wherein the TCB module is further configured to preserve trustworthiness of data stored on each untrusted module sub-system.

16. A computer program product for preserving trustworthiness of data comprising a computer usable medium including a computer readable program, wherein the computer readable program when executed on a computer causes the computer to:
store data on an untrusted system; and
commit the data to a trusted computing base (TCB), wherein said commit further causes the computer to:
upon an end of a predetermined time interval, transmit constant size authentication data from the untrusted system to the TCB; and
the TCB preserves trustworthiness of the authentication data based on performing a single hash operation of a first root and a second root of a general hash tree representing authenticated data.

17. The computer program product of claim 16, wherein the TCB verifies trustworthiness by comparing a third root of the general hash tree with a computed root value.

18. The computer program product of claim 16, wherein different hash functions are applied at different internal nodes of the general hash tree.

19. The computer program product of claim 18, wherein each internal node of the tree is computed as a hash of its children nodes, and different hash functions are applied at different internal nodes.

20. The computer program product of claim 16, wherein the different hash functions belong to a homomorphic hashing family.
